(19) United States
(12) Patent Application Publication
(10) Pub. No.: US 2021/0301955 A1
(43) Pub. Date: Sep. 30, 2021

(54) QUICK CONNECTOR STABLE FOR CONNECTION AND CONVENIENT FOR MOUNTING AND DISMOUNTING

(71) Applicant: Ningbo JuYang Toys Co., Ltd, Ningbo (CN)

(72) Inventor: Shengjun Tang, Ningbo (CN)

(73) Assignee: Ningbo JuYang Toys Co., Ltd

(21) Appl. No.: 17/315,276

(22) Filed: May 8, 2021

(30) Foreign Application Priority Data
Sep. 28, 2020 (CN) 202011039021.6
Apr. 12, 2021 (CN) 202110386358.2

(51) Int. Cl. F16L 19/08

(52) U.S. Cl. CPC F16L 19/086

(57) ABSTRACT

The present invention discloses a quick connector stable for connection and convenient for mounting and dismounting, which includes a joint pipe that is provided with a first insertion cavity and a second insertion cavity in a center with different diameters for inserting a pipe or a rod, wherein a seal cavity is respectively provided outside the first insertion cavity and the second insertion cavity, a seal ring is mounted on a bottom of the seal cavity, a gland is mounted on an upper end of the seal ring, the joint pipe is detachably connected to a screw cap, a clamping chuck is provided in the screw cap, and a locking piece is mounted between the clamping chuck and the gland.

### FIELD OF TECHNOLOGY

The present invention relates to the technical field of quick connectors, and in particular, to a quick connector stable for connection and convenient for mounting and dismounting.

### BACKGROUND

There is typically a need to connect or dismount pipes and rods in daily life. At present, in various pipe connections, in order to arrange and mount the pipes more conveniently, connectors such as elbow connectors, straight-through connectors, three-way connectors and multi-way connectors are typically used to implement turning and connection of the pipes. Conventionally, the connectors are connected by hot melting, welding and threaded connection. Due to troublesome mounting and dismounting, easy leakage in case of improper mounting and much manpower, the hot melting, welding and threaded connection have a low efficiency. The existing markets lack a quick connector that is simpler, more convenient for mounting and dismounting, able to improve the mounting efficiency greatly, and adaptive to different use scenarios.

### SUMMARY

An objective of the present invention is to provide a quick connector stable for connection and convenient for mounting and dismounting, to solve the technical problem in the background that the existing markets lack a quick connector that is simpler, more convenient for mounting and dismounting, able to improve the mounting efficiency greatly, and adaptive to different use scenarios.

To achieve the above-mentioned objective, the present invention provides the following technical solutions: a quick connector stable for connection and convenient for mounting and dismounting includes a joint pipe, a center of the joint pipe is provided with a first insertion cavity and a second insertion cavity for inserting a pipe, a seal cavity is respectively provided outside the first insertion cavity and the second insertion cavity, a seal ring is mounted on a bottom of the seal cavity, a gland is mounted on an upper end of the seal ring, an outer screw thread is provided outside two ends of the joint pipe, the joint pipe is detachably connected to a screw cap through the outer screw thread, a clamping chuck is movably mounted in the screw cap, and the first insertion cavity and the second insertion cavity have different diameters.

Preferably, a limit boss is disposed between the first insertion cavity and the second insertion cavity, and the inner diameter of the first insertion cavity is more than that of the second insertion cavity.

Preferably, a locking piece is mounted between the clamping chuck and the gland, the locking piece is an elastic spring steel tooth sleeve, the spring steel tooth sleeve includes a pressure-bearing flat ring and a plurality of steel teeth uniformly arranged inside the pressure-bearing flat ring, and the plurality of steel teeth are bent toward a direction of the gland.

Preferably, a top conical surface is provided inside a top end of the gland, the top conical surface matches with the bent steel teeth, a top pressure surface is provided in the screw cap, and when the screw cap is screwed up, the top pressure surface matches with the pressure-bearing flat ring of the spring steel tooth sleeve.

Preferably, a plurality of clamping shrapnels distributed circumferentially are arranged on a lower portion of the clamping chuck, a bump is disposed on a lower end of the clamping shrapnel, and the bump is provided with an upper conical surface on an upper side and a lower conical surface on a lower side.

Preferably, a metal clamping piece is disposed on an inside circumferential surface of the clamping shrapnel.

Preferably, a pressure conical surface is provided in the screw cap, and the pressure conical surface matches with the upper conical surface of the bump.

Preferably, the seal ring is disposed on the bottom of the seal cavity; and when the screw cap is screwed up, a lower end surface of the gland presses the seal ring, such that an inner wall of the seal ring is sealed with an outer wall of the pipe, and an outer wall of the seal ring is sealed with an inner wall of the seal cavity.

Preferably, a convex edge is disposed on the inner wall of the seal cavity, an annular groove is provided on an outside circumferential surface of the gland, the annular groove matches with the convex edge, and the width of the annular groove is more than that of the convex edge.

Preferably, a plurality of reinforcing ribs are vertically arranged outside the joint pipe and the screw cap, and an inner screw thread matching with the outer screw thread outside the joint pipe is provided inside the screw cap.

Compared with the conventional art, the present invention has the following beneficial effects:

According to the quick connector stable for connection and convenient for mounting and dismounting, with the clamping chuck movably mounted in the screw cap and the locking piece mounted between the clamping chuck and the gland, after the pipe is inserted, by screwing up the screw cap, the screw cap presses the pressure-bearing flat ring of the locking piece downward through the top pressure surface on one hand, such that the plurality of steel teeth contact the top conical surface on the upper end of the gland, and the top conical surface forces the steel teeth to move radially toward a direction close to a circle center, thereby clamping the pipe inserted into the first insertion cavity, and preventing it from getting loose; and in addition, in the process of screwing up the screw cap, the pressure conical surface presses the upper conical surface of the clamping chuck downward, such that the clamping shrapnel is closed up inward to tighten the pipe; and by this time, the inner wall of the bump clamps the pipe. Meanwhile, as the metal clamping piece is disposed on the inside circumferential surface of the clamping shrapnel, when the screw cap is screwed up, the clamping shrapnel of the clamping chuck and the embedded metal clamping piece clamp the pipe at the same. The joint is firmly connected and sealed with the pipe, so the pressure strength is enhanced to implement dual fixation, thereby preventing the connected pipe from axial displacement to damage the formed seal. The above locking piece, clamping chuck and the metal clamping piece implement triple fixation on the pipe to greatly improve the stability and reliability of the connection; and furthermore, the quick insertion, connection, and dismounting may be implemented to facilitate the use.

### BRIEF DESCRIPTION OF THE DRAWINGS

FIG. 1 is an overall structural schematic diagram of the present invention.

FIG. 2 is a sectional view of an A-A place in FIG. 1 of the present invention.

FIG. 3 is an overall exploded schematic diagram of the present invention.

FIG. 4 is a structural schematic diagram of a gland of the present invention.

FIG. 5 is a structural schematic diagram of a spring steel tooth sleeve of the present invention.

FIG. 6 is a structural schematic diagram of a joint pipe of the present invention.

FIG. 7 is a sectional structural schematic diagram of a screw cap of the present invention.

FIG. 8 is a structural schematic diagram of a clamping chuck of the present invention.

In the figures: 1. joint pipe, 101. first insertion cavity, 102. second insertion cavity, 103. limit boss, 104. seal cavity, 105. convex edge, 2. pipe, 3. seal ring, 4. gland, 401. top conical surface, 402. annular groove, 5. clamping chuck, 501. clamping shrapnel, 502. bump, 503. upper conical surface, 504. lower conical surface, 505. metal clamping piece, 61. spring steel tooth sleeve, 62. pressure-bearing flat ring, 63. steel tooth, 7. screw cap, 701. pressure conical surface, 702. top pressure surface, and 8. reinforcing rib.

### DESCRIPTION OF THE EMBODIMENTS

The technical solutions in the embodiments of the present invention will be clearly and completely described hereinafter with the accompanying drawings in the embodiments of the present invention. It is apparent that the described embodiments are only part of the embodiments of the present invention, not all of the embodiments. All other embodiments obtained by those of ordinary skill in the art based on the embodiments of the present invention without creative efforts shall pertain to the protection scope of the present invention.

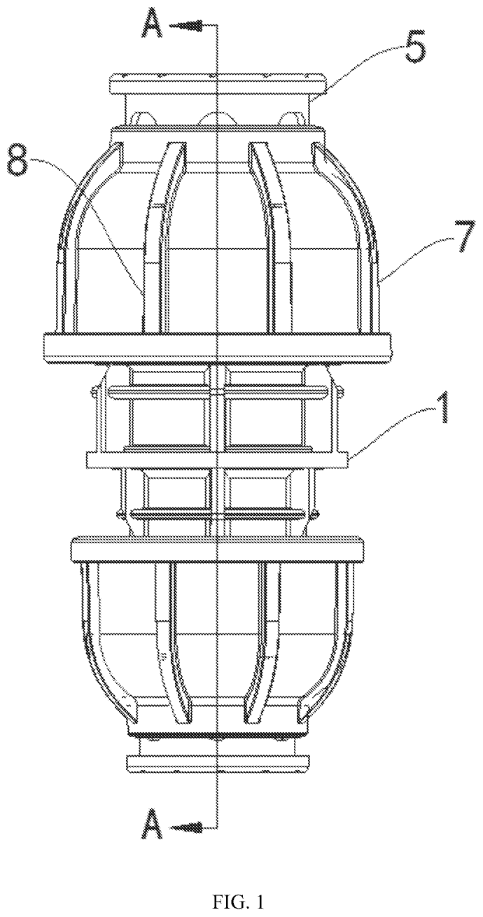

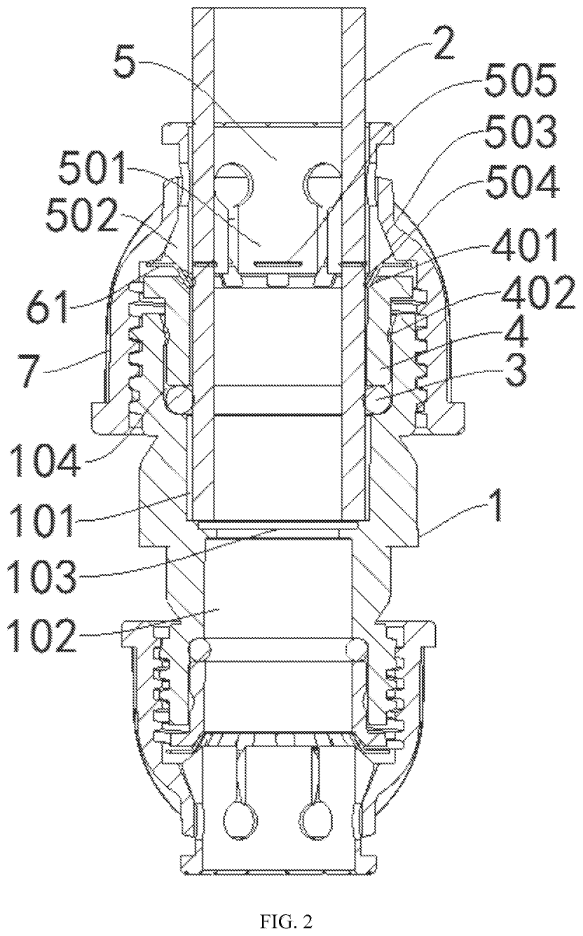

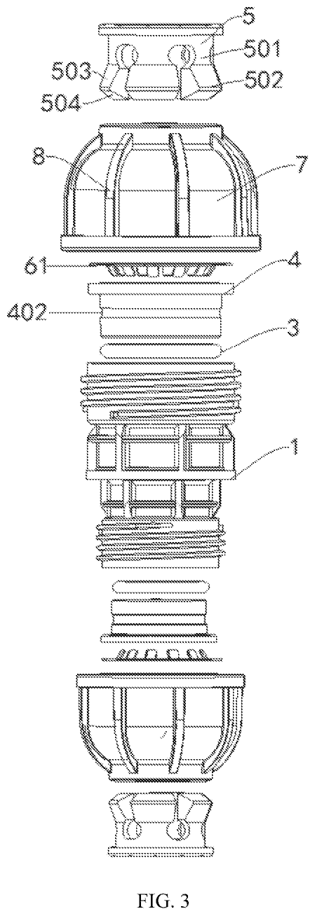

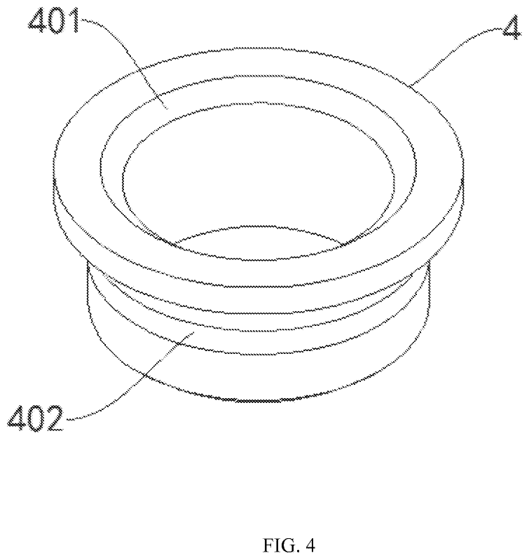

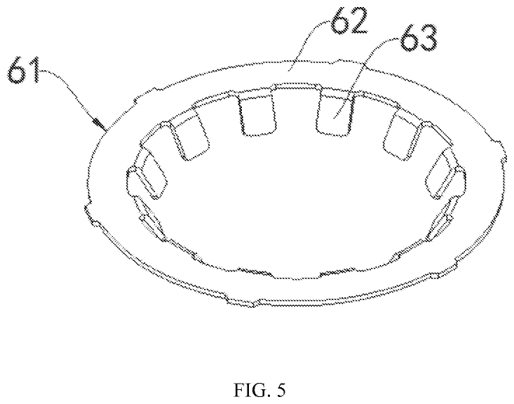

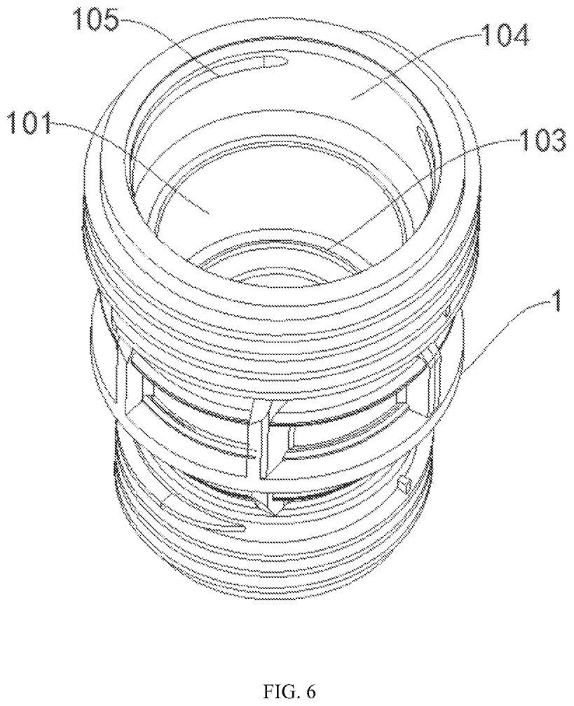

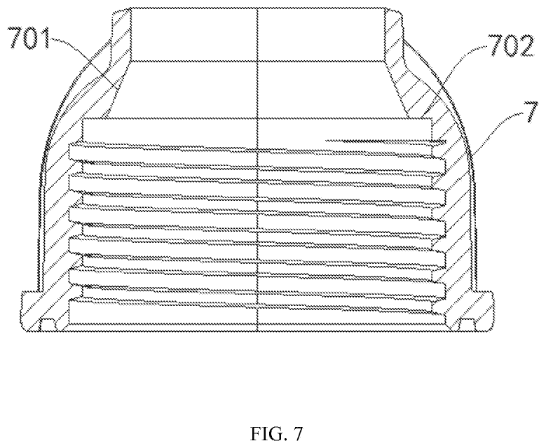

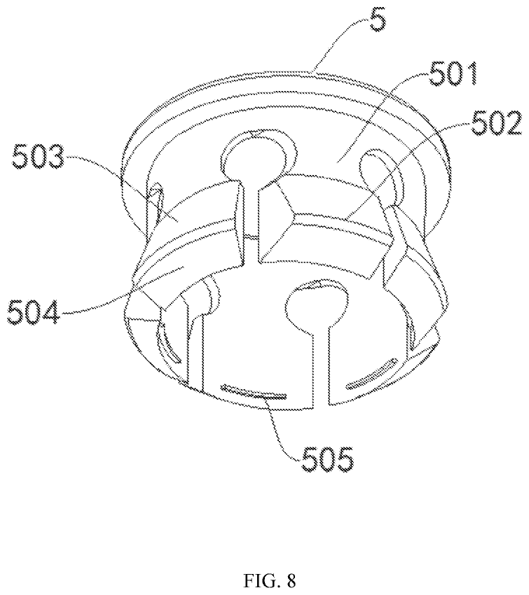

Referring to FIGS. 1-8, the present invention provides the following technical solutions: a quick connector stable for connection and convenient for mounting and dismounting includes a joint pipe 1, a first insertion cavity 101, a second insertion cavity 102, a limit loss 103, a seal cavity 104, a convex edge 105, a pipe 2, a seal ring 3, a gland 4, a top conical surface 401, an annular groove 402, a clamping chuck 5, a clamping shrapnel 501, a bump 502, an upper conical surface 503, a lower conical surface 504, a metal clamping piece 505, a locking piece, a spring steel tooth sleeve 61, a pressure-bearing flat ring 62, a steel tooth 63, a screw cap 7, a pressure conical surface 701, a top pressure surface 702 and a reinforcing rib 8. The center of the joint pipe 1 is provided with the first insertion cavity 101 and the second insertion cavity 102 for inserting the pipe 2, the seal cavity 104 is respectively provided outside the first insertion cavity 101 and the second insertion cavity 102, the seal ring 3 is mounted on a bottom of the seal cavity 104, the gland 4 is mounted on an upper end of the seal ring 3, an outer screw thread is provided outside two ends of the joint pipe 1, the joint pipe 1 is detachably connected to the screw cap 7 through the outer screw thread, the clamping chuck 5 is movably mounted in the screw cap 7, and the first insertion cavity 101 and the second insertion cavity 102 have different diameters. With the clamping chuck movably mounted in the screw cap and the locking piece mounted between the clamping chuck and the gland, after the pipe is inserted, by screwing up the screw cap, the screw cap presses the pressure-bearing flat ring of the locking piece downward through the top pressure surface on one hand, such that the plurality of steel teeth contact the top conical surface on the upper end of the gland, and the top conical surface forces the steel teeth to move radially toward a direction close to a circle center, thereby clamping the pipe inserted into the first insertion cavity, and preventing it from getting loose; and in addition, in the process of screwing up the screw cap, the pressure conical surface presses the upper conical surface of the clamping chuck downward, such that the clamping shrapnel is closed up inward to tighten the pipe; and by this time, the inner wall of the bump presses the pipe, thereby preventing the connected pipe from axial displacement to damage the formed seal. The locking piece and the clamping chuck implement dual fixation on the pipe to greatly improve the stability and reliability of the connection; and furthermore, the quick insertion, connection, and dismounting may be implemented to facilitate the use.

Further, the limit boss 103 is disposed between the first insertion cavity 101 and the second insertion cavity 102, and the inner diameter of the first insertion cavity 101 is more than that of the second insertion cavity 102. The limit boss 103 limits the inserted depth of the pipe 2, such that the pipe may be prevented from being inserted deeply or being not inserted in place, and the connection is more convenient. The inner diameter of the first insertion cavity 101 is more than that of the second insertion cavity 102, to quickly connect pipes of different diameters.

Further, the locking piece is mounted between the clamping chuck 5 and the gland 4, the locking piece is the elastic spring steel tooth sleeve 61, the spring steel tooth sleeve 61 includes a pressure-bearing flat ring 62 and a plurality of steel teeth 63 uniformly arranged inside the pressure-bearing flat ring 62, and the plurality of steel teeth 63 are bent toward a direction of the gland 4. The top conical surface 401 is provided inside a top end of the gland 4, the top conical surface 401 matches with the bent steel teeth 63, the top pressure surface 702 is provided in the screw cap 7, and when the screw cap 7 is screwed up, the top pressure surface 702 matches with the pressure-bearing flat ring 62 of the spring steel tooth sleeve 61. By screwing up the screw cap, the screw cap presses the pressure-bearing flat ring of the locking piece downward through the top pressure surface on one hand, such that the plurality of steel teeth contact the top conical surface on the upper end of the gland, and the top conical surface forces the steel teeth to move radially toward a direction close to a circle center, thereby clamping the pipe inserted into the first insertion cavity, and preventing it from getting loose.

Further, a plurality of clamping shrapnels 501 distributed circumferentially are arranged on a lower portion of the clamping chuck 5, the bump 502 is disposed on a lower end of the clamping shrapnel 501, and the bump 502 is provided with the upper conical surface 503 on an upper side and the lower conical surface 504 on a lower side. The pressure conical surface 701 is provided in the screw cap 7, and the pressure conical surface 701 matches with the upper conical surface 503 of the bump 502. In the process of screwing up the screw cap, the pressure conical surface presses the upper conical surface of the clamping chuck downward, such that the clamping shrapnel is closed up inward to tighten the pipe; and by this time, the inner wall of the bump presses the pipe, thereby preventing the connected pipe from axial displacement to damage the formed seal.

Further, the metal clamping piece 505 is disposed on an inside circumferential surface of the clamping shrapnel 501. When the screw cap 7 is screwed up, the clamping shrapnel 501 of the clamping chuck 5 and the embedded metal clamping piece 505 clamp the pipe at the same. The joint is firmly connected and sealed with the pipe, so the pressure strength is enhanced to implement dual fixation.

Further, the seal ring 3 is disposed on the bottom of the seal cavity 104; and when the screw cap 7 is screwed up, a lower end surface of the gland 4 presses the seal ring 3, such that an inner wall of the seal ring 3 is sealed with an outer wall of the pipe 2, and an outer wall of the seal ring 3 is sealed with an inner wall of the seal cavity 104.

Further, the convex edge 105 is disposed on the inner wall of the seal cavity 104, the annular groove 402 is provided on an outside circumferential surface of the gland 4, the annular groove 402 matches with the convex edge 105, and the width of the annular groove 402 is more than that of the convex edge 105. It may be ensured that the gland 4 moves in the seal cavity 104 up and down more smoothly, and after the screw cap 7 is dismounted, the gland 4 is prevented from dropping out and falling off.

Further, a plurality of reinforcing ribs 8 are vertically arranged outside the joint pipe 1 and the screw cap 7. With the plurality of reinforcing ribs 8 outside, the screw cap 7 and the joint pipe 1 may be prevented from damaging on one hand to improve the firmness. Meanwhile, the screw cap 7 and the joint pipe 1 are screwed up conveniently with a tool. An inner screw thread matching with the outer screw thread outside the joint pipe 1 is provided inside the screw cap 7.

Working principle: first of all, during connection, the pipe 2 is inserted from the clamping chuck 5, then successively passes through the locking piece, the gland 4 and the seal ring 3 and is inserted into the first insertion cavity 101 of the joint pipe 1 till an end portion of the pipe 2 is propped against the limit boss 103 in the first insertion cavity 101. Next, the screw cap 7 is screwed up by rotating. In the process of screwing up the screw cap 7, the pressure conical surface 701 of the screw cap 7 is propped against the upper conical surface 503 of the bump 502 to drive the clamping shrapnel 501 of the clamping chuck 5 to press inward, such that the clamping shrapnel 501 tightens the pipe 2. In another implementation mode, the metal clamping piece 505 is disposed on the inside circumferential surface of the clamping shrapnel 501. When the screw cap 7 is screwed up, the embedded metal clamping piece 505 of the clamping chuck 5 clamps the pipe. The joint is firmly connected and sealed with the pipe, so the pressure strength is enhanced to implement dual fixation. Meanwhile, the top pressure surface 702 of the screw cap 7 and the lower conical surface 504 of the bump 502 press the pressure-bearing flat ring 62 of the spring steel tooth sleeve 61 downward, such that the steel tooth 63 is propped against the top conical surface 401, and the top conical surface 401 forces the steel teeth 63 to move radially toward a direction close to a circle center, thereby clamping the pipe inserted into the first insertion cavity, and preventing it from getting loose. The above locking piece and clamping chuck implement dual fixation on the pipe to greatly improve the stability and reliability of the connection; and furthermore, the quick insertion, connection, and dismounting may be implemented to facilitate the use. The gland 4 presses the seal ring 3, such that the seal ring 3 deforms, and the inner wall of the seal ring 3 is sealed with the outer wall of the pipe 2, and the outer wall of the seal ring 3 is sealed with the inner wall of the seal cavity 104, thereby ensuring the quick connection and sealing between the pipe 2 and the main body of the joint pipe 1. There are a plurality of modes in use. In the first mode, only the clamping chuck 5 without the metal clamping piece 505 is used and the spring steel tooth sleeve 61 is not used; and during screwing, the clamping chuck tightens the pipe, and the joint is firmly connected and sealed with the pipe. In the second use mode, the clamping chuck 5 with the metal clamping piece 505 is used; and during screwing, the clamping chuck tightens the pipe through the clamping shrapnel 501 and the metal clamping piece 505 to implement the dual fixation. In addition, on the basis of the second mode, the spring steel tooth sleeve 61 may further be used at the same time; and during screwing, the clamping shrapnel 501 of the clamping chuck and the embedded metal clamping piece 505 clamp the pipe, and the locking piece that is the spring steel tooth sleeve 61 clamps the pipe at the same time, to implement the triple fixation.

In the embodiments of the present application, the descriptions on orientations such as “front”, “rear”, “left” and “right” are merely descriptions made according to directions shown in the accompanying drawings of the present application, rather than limits to the protection scope of the claims of the present application. In specific implementation process, other identical or similar implementation modes may be obtained according to corresponding alterations of the embodiments and are all within the protection scope of the present application. The other identical or similar implementation modes will not be repeated in the present application.

In the description of the present invention, it should be noted that, unless otherwise clearly stated and limited, the terms “mounted”, “interconnected” and “connected” should be understood broadly, for instance, it can be a fixed connection, a detachable connection or an integral connection; it can be a mechanical connection, and can also be an electrical connection; and it can be a direct connection, can also be an indirect connection by an intermediary, and can be an internal communication of two elements. Those of ordinary skill in the art may understand concrete meanings of the terms in the present invention as per specific circumstances.

At last, it is to be noted that the above contents are merely used to describe the technical solutions of the present invention, rather than to limit the present invention. Simple modifications or equivalent replacements made by those of ordinary skill in the art on the technical solutions of the present invention shall not depart from the essence and scope of the technical solutions of the present invention.

What is claimed is:

1. A quick connector stable for connection and convenient for mounting and dismounting, comprising a joint pipe (1), wherein a center of the joint pipe (1) is provided with a first insertion cavity (101) and a second insertion cavity (102) for inserting a pipe (2), a seal cavity (104) is respectively provided outside the first insertion cavity (101) and the second insertion cavity (102), a seal ring (3) is mounted on a bottom of the seal cavity (104), a gland (4) is mounted on an upper end of the seal ring (3), an outer screw thread is provided outside two ends of the joint pipe (1), the joint pipe (1) is detachably connected to a screw cap (7) through the outer screw thread, a clamping chuck (5) is movably mounted in the screw cap (7), and the first insertion cavity (101) and the second insertion cavity (102) have different diameters.

2. The quick connector stable for connection and convenient for mounting and dismounting according to claim 1, wherein a limit boss (103) is disposed between the first insertion cavity (101) and the second insertion cavity (102), and the inner diameter of the first insertion cavity (101) is more than that of the second insertion cavity (102).

3. The quick connector stable for connection and convenient for mounting and dismounting according to claim 1, wherein a locking piece is mounted between the clamping chuck (5) and the gland (4), the locking piece is an elastic spring steel tooth sleeve (61), the spring steel tooth sleeve (61) comprises a pressure-bearing flat ring (62) and a plurality of steel teeth (63) uniformly arranged inside the pressure-bearing flat ring (62), and the plurality of steel teeth (63) are bent toward a direction of the gland (4).

4. The quick connector stable for connection and convenient for mounting and dismounting according to claim 3, wherein a top conical surface (401) is provided inside a top end of the gland (4), the top conical surface (401) matches with the bent steel teeth (63), a top pressure surface (702) is provided in the screw cap (7), and when the screw cap (7) is screwed up, the top pressure surface (702) matches with the pressure-bearing flat ring (62) of the spring steel tooth sleeve (61).

5. The quick connector stable for connection and convenient for mounting and dismounting according to claim 1, wherein a plurality of clamping shrapnels (501) distributed circumferentially are arranged on a lower portion of the clamping chuck (5), a bump (502) is disposed on a lower end of the clamping shrapnel (501), and the bump (502) is provided with an upper conical surface (503) on an upper side and a lower conical surface (504) on a lower side.

6. The quick connector stable for connection and convenient for mounting and dismounting according to claim 5, wherein a metal clamping piece (505) is disposed on an inside circumferential surface of the clamping shrapnel (501).

7. The quick connector stable for connection and convenient for mounting and dismounting according to claim 5, wherein a pressure conical surface (701) is provided in the screw cap (7), and the pressure conical surface (701) matches with the upper conical surface (503) of the bump (502).

8. The quick connector stable for connection and convenient for mounting and dismounting according to claim 1, wherein the seal ring (3) is disposed on the bottom of the seal cavity (104); and when the screw cap (7) is screwed up, a lower end surface of the gland (4) presses the seal ring (3), such that an inner wall of the seal ring (3) is sealed with an outer wall of the pipe (2), and an outer wall of the seal ring (3) is sealed with an inner wall of the seal cavity (104).

9. The quick connector stable for connection and convenient for mounting and dismounting according to claim 1, wherein a convex edge (105) is disposed on the inner wall of the seal cavity (104), an annular groove (402) is provided on an outside circumferential surface of the gland (4), the annular groove (402) matches with the convex edge (105), and the width of the annular groove (402) is more than that of the convex edge (105).

10. The quick connector stable for connection and convenient for mounting and dismounting according to claim 1, wherein a plurality of reinforcing ribs (8) are vertically arranged outside the joint pipe (1) and the screw cap (7), and an inner screw thread matching with the outer screw thread outside the joint pipe (1) is provided inside the screw cap (7).
